(19) United States
(12) Patent Application Publication
(10) Pub. No.: US 2003/0187645 A1
(43) Pub. Date: Oct. 2, 2003

(54) Automatic detection of change in speaker in speaker adaptive speech recognition system

(76) Inventors: Fritz Class, Romerstein (DE); Udo Haiber, Ulm (DE); Alfred Kaltenmeier, Ulm (DE)

Correspondence Address: Stephan A. Pendorf, Pendorf & Cutliff, P.O. Box 20445, Tampa, FL, 33622-0445, US

(21) Appl. No.: 10/378,517

(22) Filed: Mar. 3, 2003

(30) Foreign Application Priority Data
Mar. 2, 2002 (DE) 102 09 324.5-53

(51) Int. Cl. G10L 15/14

(52) U.S. Cl. 704/256

(57) ABSTRACT

In many real applications such as voice control in vehicles there is the problem that the users change relatively frequently. Then the question arises: which is the correct data set for the current user? The invention provides a process making it possible automatically for the duration of operation of the system to recognize whether the speaker changes, or which (speaker dependent) data set is correct for the actual user. This task is solved by a speech recognition system which is based on a so-called Semi-Continuous Hidden Markov Model (SCHMM). Codebooks are produced, normal distribution is represented, speaker-specific data sets are stored in addition to a so-called base-line data set, and the inventive speech recognition system correlates the speech signal by means of vector quantitization with the speaker-independent and the speaker-dependent codebooks, making it possible to ascertain the identity of the speaker.

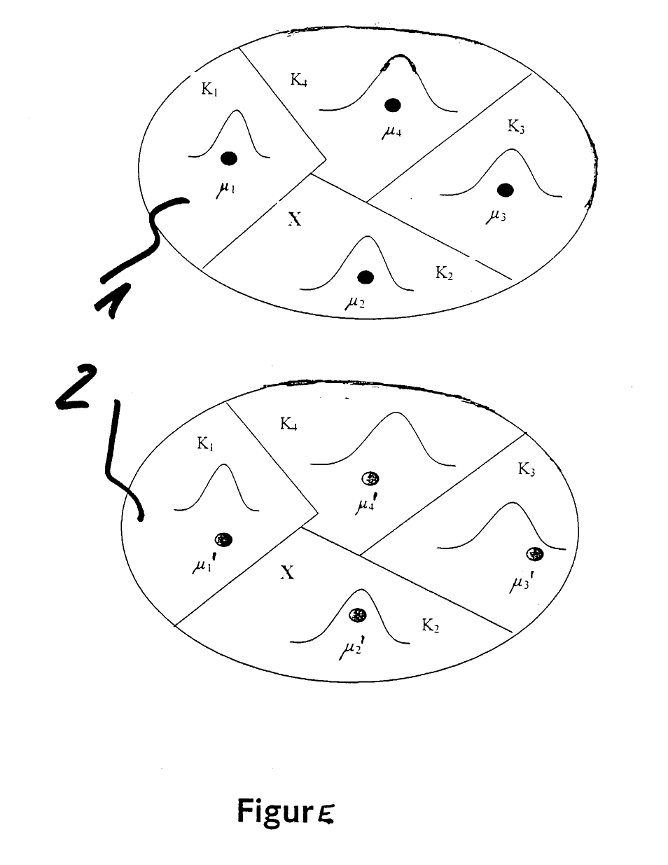

### BACKGROUND OF THE INVENTION

1. Field of the Invention

The invention concerns a process according to the precharacterizing portion of Patent claim 1.

2. Description of the Related Art

Automatic speech recognition, at least simple versions thereof, is employed today already in products for example for control and operation of devices and machines or telephone-based information systems. These speech recognizers are, as a rule, in principle designed for speaker-independent recognition, that is, any user can use the system without an explicit training phase and speak the necessary words or, as the case may be, commands. This speaker independence is achieved in that during the basic training of the system in the laboratory very many speech test samples of various speakers and using a greatly varied vocabulary are carried out.

Beyond this, methods are employed for adapting the speech recognition system, also online, during an actual use or application to the special conditions with respect to the speaker and equipment (microphone, amplifiers, space). These adaptation methods can be employed with monitoring as well as without monitoring.

Non-monitored adaptation means that the recognition system continuously adapts to the actual situation unnoticed by the user. For this, as a rule, drag windows are employed, which progressively skewed over time carry out particular parameters of the system. The time constant of the drag window (the frequency also referred to as the “rate of forgetting”) determines the adaptation speed.

In monitored adaptation a user must explicitly repeat specific words or sentences in the training phase, which are provided to him by the system (acoustically or optically). From these inputs (speech samples) speech specific parameters are generated in the system or, as case may be, updated and optimized. The method of the monitored adaptation is frequently employed in the case of speakers for which the speech recognition dependent basic system has a very poor recognition rate and for which no significant improvement of the recognition yield is achievable in the case of the methodology of the monitored adaptation. This monitored adaptation should naturally occur only once and the appropriate speaker specific data set should be employed each time this specific user uses the system.

In both methods, monitored as well as the unmonitored adaptation, speaker specific parameter sets are stored in addition to the base parameters. In many real applications such as, for example, “speech operation in vehicles”, there is the problem that the users change relatively frequently. If then for each (or a few) users speaker-specific data sets are created, then the question arises, which is the correct data set for the actual user? This could naturally occur by interrogation during each system new start-up. Besides the fact that this is a very inconvenient and not very user-friendly method, it also frequently occurs that the speaker changes while the system is already activated and thus no new preinitialization is possible.

### SUMMARY OF THE INVENTION

It is the task of the invention, to find a process, which makes it possible, automatically for the duration of operation of the system to recognize whether the speaker changes, or as the case may be which (speaker dependent) data set is correct for the actual user.

This task is solved by a speech recognition system which is based on a so-called Semi-Continuous Hidden Markov Model (SCHMM) (Huang, xuedong D., Y. Ariki and M. A. Jack Hidden Markov models for speech recognition, Edinburgh information technology series, Edinburgh University Press, Scotland, 1990). In association with the classification on the basis of the Semi-Continuous Hidden Markov Model, codebooks are produced which are comprised of n-dimensional normal distributions. Therein each normal distribution is represented by its average value vector μ and its co-variance matrix K. In the framework of a speaker adaptation there are, as a rule, the parameters of these normal distributions, that is, average value and/or co-variants matrix, changed speaker-specific. These speaker-specific data sets are then stored supplemental to the so-called base-line data set, which corresponds to a speaker-independent codebook. In inventive manner the speech recognition system correlates the speech signal by means of vector quantitization with the speaker-independent and the speaker-dependent codebooks. On the basis of the correlation it then becomes possible for the recognition system to assign or associate the speech signal to one of these codebooks and therewith to ascertain the identity of the speaker.

In this preferred manner of proceeding the invention allows the detection of a change in speaker exclusively from the speech signal itself, without having to draw from the use of methods known from the state of art for speech recognition. A near-lying solution of the task of this type has the disadvantage, that as a consequence of the speech recognition or, as the case may be, speech verification a separate recognition system would be required, which must be active in parallel to the speech recognition system. Such a second system is however not practical in some systems due to complexity or, as the case may be, cost reasons.

The subject of the present invention thus describes a method with which, using parameters derived from the speech signal, it can be recognized directly whether a speaker change has occurred. In the same step it is in advantageous manner also possible to determine which stored set of parameters (codebook) of the classifier is optimal for the speech recognition in the case of the actual speaker.

In the above-mentioned methods for speech adaptation, in advantageous manner, the parameters of the normal distribution, that is, average value and/or co-variance matrixes, are changed in speaker specific codebooks, in comparison to the speaker independent codebook. These speaker specific data sets (speaker dependent codebook) is then stored supplementally to the so-called base line data set (speaker independent codebook).

In the application phase of this recognition system a so-called vector quantatization occurs. This is a classification of characteristics vectors, which can be derived from the speech signal, to the normal distributions. This classification provides “probability values” p(x,k) of a characteristic vector for each normal distribution of the codebook.

On the basis of the subsequent example scenario the principle of the inventive process is described in detail.

### BRIEF DESCRIPTION OF THE DRAWING

Therein this figure shows two exemplary codebooks, which can be drawn upon for recognition of speaker change.

### DETAILED DESCRIPTION OF THE INVENTION

The speaker independent codebook 1 in the Figure is comprised of respectively 4 normal distributions (“standard-codebook”) with parameters μ₁. . . μ₄ (average value vector) and the associated co-variance matrixes K₁ . . . , K₄. In an adaptation phase the speaker trains the system. Therein the average value vectors and co-variance matrices of the standard codebook are modified and there results a speaker dependent codebook 2 with the new speaker specific average values μ₁′. . . , μ₄′. This post-trained codebook 2 (or as the case may be only the new average value vectors) are supplementally stored.

In the application phase of the recognition system there are thus now available, for example, 2 codebooks: the standard codebook 1 for speaker independent recognition, as well as codebook 2 which was subsequently trained for a specific speaker; in principle of course naturally any amount of post-trained codebooks may be available, without leaving the spirit and scope of the inventive process. For each incoming or arriving characteristic vector X from the speech signal there is then carried out a classification (so-called “vector quantitization”) in all normal distributions of both codebooks. In the present example we obtain for the standard codebook 1 the value p(X,1)=0.2 (probability of the first normal distribution), p(X,2)=0.6, p(X,3)=0.1, p(X,4)=0.1. Corresponding values are produced for the post-trained codebook 2, for example p(X,1)=0.3, p(X,2)=0.4, p(X,3)=0.1, as well as p(X,4)=0.2.

Conventionally a threshold value is employed, in order to exclude very small probability values. In the present example this threshold value is 0.15. This means that, here, only the probability value p(X,1)=0.2 and p(X,2)=0.6 of the standard codebook 1 as well as p(X,1)=0.3, p(X,2)=0.4 and p(X,4)=0.2 of the post-trained codebook 2 lie above the threshold value and are relevant for further consideration. As the next step a norming to “sum=1” is carried out.

$$\frac{1}{{\sum }_{k = 1}^{N} p ( x , k )} \cdot p ( x , k ) \qquad \text{Equation 1}$$

N is the number of probabilities, which lie above the threshold value; that means in the present example N=2 for the standard codebook 1 and N=3 for the post-trained codebook 2 and k refers to the normal distribution within the codebooks of which the appropriate probability value is assigned or associated. The first part of the equation produces the so-called norming factor F according to

$$F = \frac{1}{{\sum }_{k = 1}^{N} p ( x , k )} \qquad \text{Equation 2}$$

For each codebook there results therewith a special norming factor, in the present example

F_{standard}=1.25 for codebook 1

F_{post-trained}=1.11 for codebook 2

The norming factor F is then interpreted in the following manner: the closer the characteristic vector is to the mean of the normal distribution of a codebook, that means, the greater the probability value for this vector, the greater the likelihood that this codebook corresponds to the actual speaker. From Equation (2) it can be seen that the norming factor becomes smaller the greater the probability value is. In the present example the process would decide for the post-trained speaker.

The decision criteria for a speaker change is thus the norming factor according to Equation (2).

Different embodiments of the invention are thus possible:

Decision for each individual characteristic vector during the total recognition process or operation, wherein in advantageous manner the decision is arrived at as rapidly as possible, so that an operation of the process is possible in real time, or

Decision only for the first expression or utterance (word, sentence) of a speaker; thereafter the decision is frozen; that means, for a certain period of time, for example until a significant speech pause has occurred, only the codebook associated with the first utterance is employed.

1. Process for automatic detection of speaker change in speech recognition systems, which operate on the basis of Hidden Markov Models, and which rely on a speaker independent codebook, which are comprised of n-dimensional normal distributions, thereby characterized, that besides the speaker-independent codebook, at least one speaker-dependent codebook exists, and that the speaker recognition system correlates a speech signal by means of vector quantitization with the speaker-independent and the speaker-dependent codebooks, and on the basis of this correlation decides upon the identity of a speaker.

2. Process according to claim 1, thereby characterized, that from the probability value resulting from the vector quantitization, only those which exceed a certain predetermined threshold value are submitted for correlation.

3. Process according to one of claims 1 or 2, thereby characterized, that, prior to the correlation of the probability values resulting from the vector quantitization for each of the codebooks, a norming factor F is calculated, wherein:
$$F = \frac{1}{{\sum }_{k = 1}^{N} p ( x , k )} .$$

4. Process according to claim 3, thereby characterized, that that codebook is assigned as belonging to the speech signal, which exhibits the smallest norming factor F with respect to this speech signal.

5. Process according to one of claims 1 through 4, thereby characterized, that the process continuously, if possible in real time, examines the speech signal for speaker change.

6. Process according to one of claims 1 through 4, thereby characterized, that the process undertakes a speaker identification only by reference to a portion of a sequence of the speech signal, and maintains the therefrom resulting selection for the total sequence.

7. Process according to claim 6, thereby characterized, that this partial sequence is the beginning of a word or the beginning of a sentence.
